(19) United States
(12) Patent Application Publication
(10) Pub. No.: US 2018/0225691 A1
(43) Pub. Date: Aug. 9, 2018

(54) METHOD, SYSTEM, AND PROGRAM PRODUCT FOR CONVEYING PURCHASE ENHANCEMENTS

(71) Applicant: Retail Gaming Solutions, LLC, Troy, NY (US)

(72) Inventors: Jeffrey Stevens Perlee, Altamont, NY (US); Jesse Nathaniel Booth, Delmar, NY (US); Guha Bala, Latham, NY (US); Karthik Bala, Menands, NY (US); Scot Schechner, Saratoga Springs, NY (US)

(21) Appl. No.: 15/891,333

(22) Filed: Feb. 7, 2018

Related U.S. Application Data
(60) Provisional application No. 62/455,916, filed on Feb. 7, 2017.

(51) Int. Cl. G06Q 30/02

(52) U.S. Cl. CPC G06Q 30/0212; G06Q 30/0226; G06Q 30/0238; G06Q 30/0209

(57) ABSTRACT

The disclosure provides a computer-implemented method for automatically conveying a purchase enhancement, the method including: identifying a transaction between a user and a point of service (SP), the SP being communicatively coupled to a transacting agent; applying a tokenized credit to a user profile of the user based on the transaction between the user and the SP; generating a non-determinative user interaction based on the tokenized credit; verifying interaction by the user based on the non-determinative user interaction; and automatically conveying a purchase enhancement to the user, based on the verifying.

### BACKGROUND

The present disclosure relates generally to process methodologies for automatically conveying one or more purchase enhancements to users, e.g., based on whether the users engage one or more preferred points of service, and/or verifying human interaction through non-determinative user interactions. Specifically, the present disclosure provides methods, systems, and program products for automatically conveying one or more purchase enhancements in response to or included within a specific transaction in which a user engages one of multiple points of service (“SPs,” hereafter), e.g., terminals, games, lotteries, marketplaces for physical and/or virtual goods, subscriptions, fabrication devices, and/or other mechanisms, locations, etc., for purchasing real or virtual goods and services.

User interaction with SPs is a crucial aspect of providing a pleasant and memorable experience to users in electronic commerce. For example, an operator of an amusement park, physical or virtual casino, physical or virtual arcade, etc., may furnish a plurality of SPs (e.g., kiosks, access points, tablets, and/or other interconnected devices) to provide a centralized profile and/or uniform user experience across the park, arcade, casino, or similar establishment. Such experiences can be replicated or otherwise simulated in a virtual environment, e.g., an online game, a virtual casino, and/or other simulated environment with which a user may interact. Individual SPs may correspond to distinct features and/or functionality. The various SPs may, in many instances, be administered by parties other than the user or the operator of the environment where such SPs are furnished. A user thus may be required to use multiple profiles for each SP, or may not have a profile with which to access or operate one or more of the available SPs in a particular setting. For some users, the value of some SPs relative to others may be diminished or unclear. In other cases, a user may have insufficient interest in a particular SP and its related products or services but may be amenable to using such products or services when corresponding incentives are available. Still other concerns may pertain to, e.g., increasing user enjoyment and incentive to use rewards programs. A conventional sweepstakes or points program, for example, may offer limited amounts of user interaction and reduce the number of users who actively take advantage of such programs for providing user rewards and incentives for continued engagement.

### SUMMARY

A first aspect of the present disclosure provides a computer-implemented method for automatically conveying a purchase enhancement, the method including: identifying a transaction between a user and a point of service (SP), the SP being communicatively coupled to a transacting agent; applying a tokenized credit to a user profile of the user based on the transaction between the user and the SP; generating a non-determinative user interaction based on the tokenized credit; verifying interaction by the user based on the non-determinative user interaction; and automatically conveying a purchase enhancement to the user, based on the verifying.

A second aspect of the present disclosure provides a program product stored on a computer readable storage medium, the program product operable to automatically convey a purchase enhancement, the computer readable storage medium including program code for: identifying a transaction between a user and a point of service (SP), the SP being communicatively coupled to a transacting agent; applying a tokenized credit to a user profile of the user based on the transaction between the user and the SP; generating a non-determinative user interaction based on the tokenized credit; verifying interaction by the user based on the non-determinative user interaction; and automatically conveying a purchase enhancement to the user, based on the verifying.

A third aspect of the present disclosure provides a system for automatically conveying a purchase enhancement to a user, the system including: a service management system stored in an electronic data processing system and configured to operate independently from a first plurality of user-engageable points of service (SPs), the service management system including program code for identifying a transaction between a user and an SP; a transacting agent communicatively coupled to the SP, the transacting agent including program code for: applying a tokenized credit to a user profile of the user based on the transaction between the user and the SP; generating a non-determinative user interaction based on the tokenized credit; verifying interaction by the user based on the non-determinative user interaction; and automatically conveying a purchase enhancement to the user, based on the verifying.

A fourth aspect of the present disclosure provides a computer-implemented method for automatically conveying a purchase enhancement, the method including: identifying a transaction between a user and a point of service (SPs), the SP being communicatively coupled to a transacting agent; applying a tokenized credit to a user profile of the user based on the transaction between the user and the SP; converting the tokenized credit to a corresponding purchase enhancement; and automatically conveying the corresponding purchase enhancement to the user profile.

A fifth aspect of the present disclosure provides a program product stored on a computer readable storage medium, the program product operable to automatically convey a purchase enhancement, the computer readable storage medium including program code for: identifying a transaction between a user and a point of service (SP), the SP being communicatively coupled to a transacting agent; applying a tokenized credit to a user profile of the user based on the transaction between the user and the SP; converting the tokenized credit to a corresponding purchase enhancement; and automatically conveying the corresponding purchase enhancement to the user profile.

A sixth aspect of the present disclosure provides a system for automatically conveying a purchase enhancement to a user, the system including: a service management system stored in an electronic data processing system and configured to operate independently from a first plurality of user-engageable points of service (SPs), the service management system including program code for identifying a transaction between a user and an SP; a transacting agent communicatively coupled to the SP, the transacting agent including program code for: applying a tokenized credit to a user profile of the user based on the transaction between the user and the SP; converting the tokenized credit to a corresponding purchase enhancement; and automatically conveying the corresponding purchase enhancement to the user profile.

A seventh aspect of the present disclosure provides a computer-implemented method for automatically enhancing a modified product, the method including: tagging a user-engageable fabrication device in a first plurality of user-engageable fabrication devices as being a preferred device; determining whether a user, having a profile stored in an electronic data processing system, engages the preferred device; determining whether the profile includes an authorization for product modification; causing the preferred fabrication device to fabricate a non-modified product in response to the profile not including the authorization for product modification; and causing the preferred fabrication device to fabricate a modified product in response to the profile including the authorization for product modification.

### BRIEF DESCRIPTION OF THE DRAWINGS

These and other features of the disclosed apparatus will be more readily understood from the following detailed description of the various aspects of the apparatus taken in conjunction with the accompanying drawings that depict various embodiments of the invention, in which:

FIG. 1 is a schematic diagram of a system for conveying purchase enhancements according to an embodiment of the disclosure.

FIG. 2 is an illustrative environment which includes a computer system for implementing embodiments of the disclosure.

FIG. 3 is a flow diagram of an example method according to an embodiment of the disclosure.

FIG. 4 is a flow diagram of an example method according to further embodiments of the disclosure.

FIG. 5 is a diagram of a non-determinative user interaction according to an embodiment of the disclosure.

FIG. 6 is another illustrative environment which includes a computer system for implementing embodiments of the disclosure.

FIG. 7 is another flow diagram of an example method according to an embodiment of the disclosure.

It is noted that the drawings are not necessarily to scale. The drawings are intended to depict only typical aspects of the disclosure, and therefore should not be considered as limiting its scope. In the drawings, like numbering represents like elements between the drawings.

### DETAILED DESCRIPTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Embodiments of the disclosure also include increasing user engagement and retention in systems for incentivizing interaction with user-engageable points of service (“SPs”), e.g., by applying tokenized credits to users who interact with SPs, and using a non-determinative user interaction to verify users as well as incentivize continued use of rewards programs. Further embodiments may also include processes for automatically conveying purchase enhancements to users associated with particular user profiles. In a further example, the processes described herein may include tagging (e.g., identifying, modifying, or otherwise selecting) one of multiple user-engageable points of service (“SPs”) as being preferred, e.g., by an administrator, third party, etc. To reward users who engage the one or more SP(s) in the group, a system and/or its administrator(s) can apply a tokenized credit to the profile of a user who engages in a transaction with an SP. The system can thereafter accept one or more tokenized credits from the user and automatically convey one or more corresponding purchase enhancements to the user's profile. The user may redeem tokenized credits for purchase enhancements by acting on a non-determinative user interaction, e.g., an animation, application, and/or other activity with no effect on the purchase enhancements conveyed to the user. Such activities may simulate a game of skill, despite the outcome of the simulated game having been predetermined via chance or the operator of a system. The simulated game of skill can verify the identity of a user and/or increase user enjoyment of the system.

According to an example embodiment, the method may be embodied as an administrative system utilized in a real-world or virtual casino, arcade, etc., in which users interact with various games (e.g., a form of user-engageable SP) to earn rewards, e.g., money, products, and/or wholly virtual benefits such as avatar customization options, access to other games, etc. The administrative system can automatically apply a tokenized credit (e.g., an increase or modification in point balance) to users who choose to play one or more games and/or participate in other transactions in the casino, arcade, etc. The administrative system can then allow users who have accumulated tokenized credits to exchange those credits for one or more rewards which may be distinct from other rewards offered in the same casino, arcade, etc. Where desired or applicable, accumulated balance in a user's account may be redeemable only for additional games, sweepstakes, contests, etc., by the operator and/or administrator of a particular rewards system. In some instances, the tokenized credits may be redeemable by way of a sweepstakes having one or more interactive or audio-visual components. In some cases, the tokenized credits may be redeemed for entry into a sweepstakes, with a reward to the user being determined at the time of redemption but not immediately communicated to the user. The user may then participate in a non-determinative user interaction, e.g., an animation which simulates another arcade game, to reveal one or more rewards. The use of a non-determinative user interaction may automatically verify users, while increasing user engagement and retention in the casino which provides tokenized credits.

In a more specific example, the various SPs in a particular system may offer only virtual rewards with no economic or transferrable value. In such cases, the virtual rewards may be conveyed to and/or stored only within a user profile without being transferrable or usable outside a particular interactive system, e.g., a virtual casino or suite of virtual casinos. However, a user may nevertheless use accumulated tokenized credits (e.g., points) to obtain cash rewards, physical products, etc., and/or participate in an additional sweepstakes for items with real-world value, or otherwise being different from rewards offered by the SPs themselves.

In further embodiments, the processes described herein can be independent from the administrator(s) or operator(s) of points of service included, e.g., a real casino, virtual casino, or other entertainment complex, such that users can receive tokenized credits in exchange for visiting a variety of independent establishments. The user may also be able to exchange tokenized credits for one or more rewards tailored to their personal interests, e.g., reflected in a user profile. The tokenized credits, however obtained, may be redeemable in a sweepstakes, exchange, etc., which is wholly independent from the marketplace where tokenized credits are originally distributed. In addition, embodiments of the present disclosure can include or otherwise draw functionality from one or more real-world transactions between the user(s), one or more administrators, and/or one or more third parties. Technical effects of the present disclosure can also include, e.g., verifying users by way of non-determinative user interactions generated upon redemption of tokenized credits, automatically modifying one or more products purchased by a user in exchange for accepting tokenized credits accumulated by the same user in order to provide instantly customizable items as a reward for past transactions, and/or providing a user verification and retention program which is wholly independent from the goods, services, etc., offered in tandem with the verification and retention program.

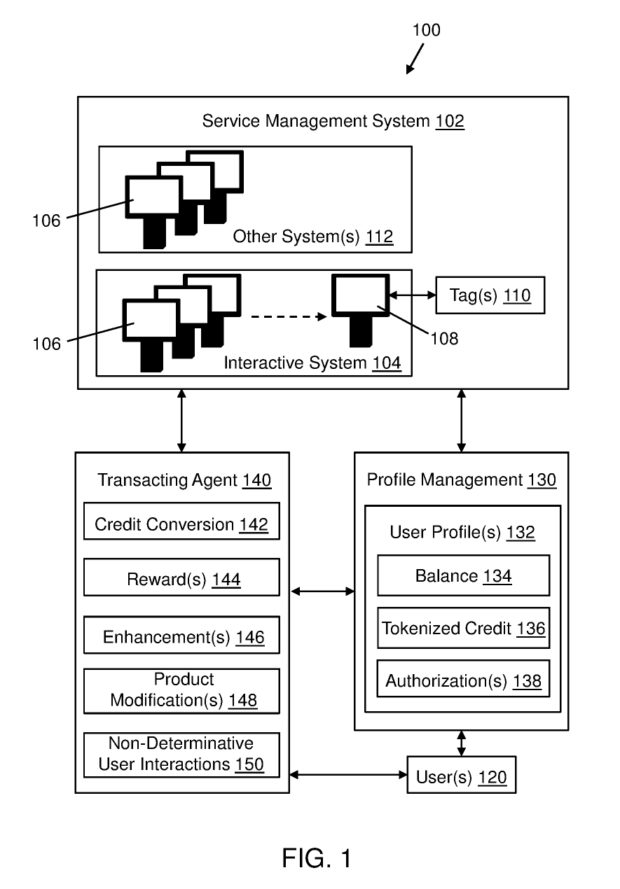

Referring to FIG. 1, a schematic diagram of a purchase enhancement system 100 according to embodiments of the present disclosure is shown. Purchase enhancement system 100 can include, e.g., a service management system 102 which includes or otherwise is in communication with an interactive system 104. Interactive system 104 can include or represent, e.g., a collection of user-engageable points of service (“SPs”) 106 configured to provide one or more products or services to individuals as discussed herein. As discussed herein, a “SP” generally refers to any device, interface, kiosk, etc., whether included within a physical structure or software product, configured to produce a product or service in exchange for an input from a user (e.g., tending cash, virtual currency, etc.). Each SP 106 can further include, e.g., a personal digital device (e.g., PC, phone, tablet, etc.), an optical scanner, and/or any other currently-known or later developed hardware or software system for providing access to interactive system 104. Thus, interactive system 104 can include or otherwise be embodied as a physical and/or virtual casino, arcade, or marketplace where one or more users may interact with plurality of SPs 106 to enter into one or more transactions.

In some cases, an administrator of service management system(s) 102 and/or interactive system(s) 104 may optionally designate one or more of SPs 106 as a preferred SP 108 as part of, e.g., a sales promotion, partnership with third parties, after installing new SPs 106 for use, etc. To designate one or more SPs 106 as preferred SP(s) 108, embodiments of service management system 102 can be configured to assign one or more tags 110 (e.g., data tags, add-on devices or circuits, etc.,) to SPs 106 selected to convey purchase enhancements as discussed herein. Terminals 106 which do not receive corresponding tag(s) 110 would be considered non-preferred SPs and thus may optionally not dispense tokenized credits, predetermined purchase enhancements, etc., to a user. In a more general example, every SP 106 would be configured to dispense tokenized credits capable of being redeemed for purchase enhancements as discussed herein.

A user 120 of system 100 may interact with user-engageable SP(s) 106 and preferred SP(s) 108 through a profile management system 130. Profile management system 130 may be embedded within SP(s) 106, 108 as a software component thereof and/or may be included as part of an external device in communication with SP(s) 106, 108. User 120 can create and maintain a user profile 132 stored within profile management system 130. Terminal(s) 106 of service management system 102 can receive payments, subscriptions, redemptions, etc., from user(s) 120 associated with user profile(s) 132, e.g., by scanning, manual entry of codes into an electronic data processing system, and/or other mechanisms to initiate processes according to the present disclosure.

In addition to various types of personal and economic information relative to user(s) 120, user profile 132 can include a balance 134 of credits, points, dollars, etc., stored by user 120 which may be used for interaction with SP(s) 106, 108 and/or other points of interaction with a particular seller or administrator. User profile(s) 132 may be configured to store various tokenized credit(s) 136 which may be redeemed for one or more sweepstakes entries, purchase enhancements, rewards, etc., as described herein. Tokenized credit(s) 136 can be submitted to profile management system 130 by one or more other remote and/or in-person means (e.g., by mail, phone, manual entry, etc.). User profile(s) 132 can additionally or alternatively include authorization(s) 138 for accepting one or more purchase enhancements, e.g., modified products, sweepstakes entries, etc., as described herein relative to various embodiments. In some cases, the interaction between user(s) 120 and SP(s) 106, 108 may be independent from a retailer, site administrator, and/or other entity responsible for the space where SP(s) 106, 108 are available. It is therefore understood that embodiments of the present disclosure can be operable to serve user(s) 120 without the participation of one or more people, businesses, etc., that may allow SP(s) 106, 108 to be available at a particular location.

Service management system 102 can be in communication with profile management system 130, e.g., through any currently known or later developed form of wired and/or wireless network connection, and/or combinations thereof. Profile management system 130 can be stored in a data processing system (e.g., the same as or similar to such as a computer system as described herein) and/or within an independent database. One or more user profiles within profile management system 130 corresponding to user(s) 120 can further be saved within profile management system 130, or can be copied/read from a separate electronic database (not shown) in communication with profile management system 130. In an embodiment, user 120 can register for and/or log into a user profile provided through profile management system 130, e.g., by connecting to a website or visiting a place of service where user 120 can access user profile(s) 132 of profile management system 130.

In an illustrative example, user 120 can create one or more user profile(s) 132 manually, e.g., through personally accessed or externally furnished computer system(s) available at a particular retail site or other physical and/or online location, such as a grocery store, convenience store, webpage, virtual environment, etc. It is also understood that profile management system 120 and/or user profile(s) 132 may be independent from and/or separately managed relative to other devices, components, etc., described herein. As examples, user profile(s) 132 can correspond to one or more individual users, device identifications (e.g., serial numbers or accounts tied to one or more devices), a particular user name and password which may be assigned to an organization or other collection of individuals, a unique ID or other identity originating from a third party account, etc.

System 100 can also include a transacting agent 140 for executing steps (e.g., reading and/or writing data in) related to SPs 106 of interactive system 104 and/or service management system 102, and user profiles from profile management system 130. It is therefore understood that some steps and functions performed herein relative to transacting agent 140 can alternatively be implemented through service management system 102, profile management system 130, etc. Transacting agent 140 can be configured, e.g., to furnish one or more rewards 144, e.g., cash, products, services, discounts, subscriptions, purchase incentives, package deals, etc., to user(s) 120 directly, or through profile management system 130. Transacting agent 140 can also include a credit conversion module 142 for converting tokenized credit(s) 136 to corresponding reward(s) 144. In an embodiment, transacting agent 140 can access inventories, lists, etc., of available reward(s) 144 available through and/or suggested by the operator interactive system 104 and/or third parties.

In addition or alternatively to reward(s) 144, transacting agent 140 can include a listing of purchase enhancements 146 capable of being conveyed to user(s) 120, e.g., in exchange for accumulated tokenized credits 136 in balance 134. Such enhancements 146 can include, e.g., modifications to other reward(s) 144, additional products, sweepstakes entries for a chance at receiving reward(s) 144, various discounts and economic promotions, etc. As a further addition or alternative, transacting agent 140 can be configured to convey one or more product modification(s) 148 (e.g., additional features, functionality, etc.) affecting other products (e.g., reward(s) 144) provided to user(s) 120. Transacting agent 140 can also be configured to execute processes including, e.g., authorizing user profile(s) 132 to engage SP(s) 106 included in other systems 112 besides interactive system 104.

Transacting agent 140 may also include, e.g., one or more non-determinative user interactions 150, configured for generation on transacting agent 140, SP(s) 106, and/or other components accessible to user(s) 120. Non-determinative user interaction(s) 150 may take a variety of forms, and generally provide an audio-visual enhancement to participants in a sweepstakes or game of chance. In a conventional sweepstakes, user(s) 120 may tender one or more contest entries in exchange for the chance to possibly receive reward(s) 144 via a random drawing. In this case, user(s) 120 may receive written notifications from the sweepstakes operator as to one or more of their sweepstakes entries are redeemable for reward(s) 144. A sweepstakes conducted in this manner offers little to no user engagement or interactivity during the accompanying sweepstakes drawings, and moreover is not configured to verify whether user(s) 120 are human users. Embodiments of the present disclosure may rely upon determinative user interaction(s) 150 to address these shortcomings in a conventional sweepstakes. A non-determinative user interaction 150 supplants the use of a traditional message, picture, and/or other notification to user(s) 120 informing user(s) 120 of the outcome of a sweepstakes.

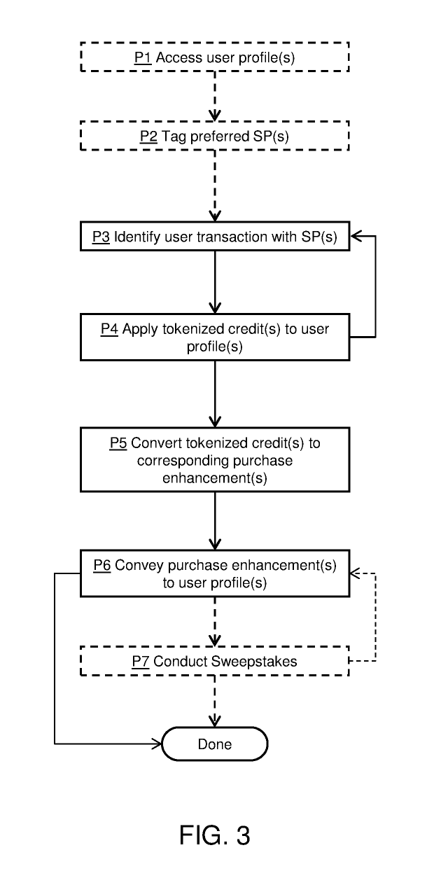

Non-determinative user interaction 150 may take the form of, e.g., a simulated game play in which user(s) 120 interact with one or more interactive elements on a display to learn which reward(s) 144 they have received in the sweepstakes. A defining characteristic of non-determinative user interaction 150 may include, e.g., the reward(s) 144 to user(s) 120 being selected by transacting agent 140 before non-determinative user interaction 150 even begins. User(s) 120 may then participate in non-determinative user interaction(s) 150 to learn which reward(s) 144 they have received. Transacting agent 140 furthermore may be configured to determine whether user(s) 120 are human users, as opposed to machine users, based on whether non-determinative user interaction(s) 150 have been used to claim reward(s) 144. Further examples of non-determinative user interaction(s) 150 are shown, e.g., in FIG. 3 and described in further detail elsewhere herein.

In the example of a virtual casino, a user can be authorized to play additional games beyond a predetermined initial set of games or digitally enter into additional sweepstakes beyond a predetermined initial set of sweepstakes, e.g., as a reward for the exchange of tokenized credit(s) 136 or the repeated use of SP(s) 106 and/or preferred SP(s) 108. User profile(s) 132 can thus include an adjustable status level based on past or present interactions, such that the status of user profile(s) 132 is associated with a corresponding number of interactive systems 104, 112. For example, each user profile(s) 132 can include a corresponding metal level (e.g., bronze, silver, gold, platinum, diamond, etc.) or numerical level for granting access to a corresponding number of interactive systems 104, 112 and corresponding SP(s) 106, 108. The status level of user profile(s) 132 can thus be adjusted in a number of ways, e.g., engaging in multiple transactions, using preferred SP(s) 108, logging into user profile(s) 132 a predetermined number of times, and/or combinations of these requirements and/or other requirements. In any event, credit conversion module 142 of transacting agent 140 can be operable to accept tokenized credit(s) 136 in exchange for conveying rewards 144, enhancements 146, product modifications 148, etc., based on an automatic or manual selection by a user 120 submitted to transacting agent 140 directly or indirectly through profile management system 130.

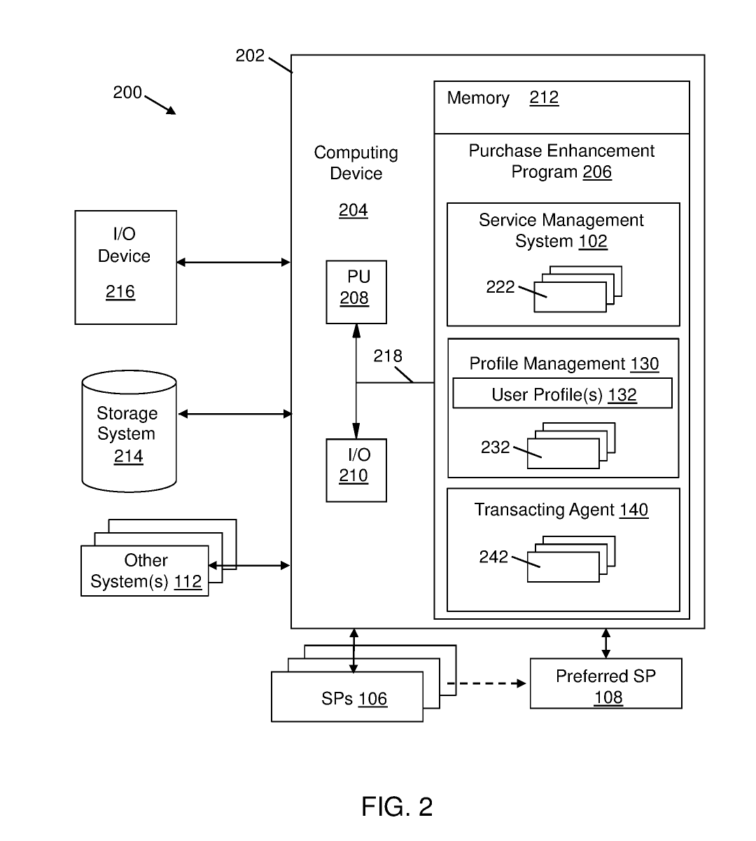

Turning now to FIG. 2, an illustrative environment 200 for implementing the methods and/or systems described herein is shown. In particular, a computer system 202 is shown as including one or more computing devices 204. Computing device 204 can include service management system 102, profile management system 130, and/or transacting agent 140, e.g., as one or more software components as discussed herein, or otherwise can be in communication with the various systems discussed herein embodied as stand-alone systems or hardware implementations. Service management system 102, profile management system 130, and transacting agent 140 are described herein as being embodied as software components solely for ease of illustration and explanation. Computing device 204 can include a purchase enhancement program 206 thereon for automatically conveying purchase enhancements to one or more users 120 (FIG. 1) by performing any/all of the processes described herein and implementing any/all of the embodiments described herein.

Computer system 202 is shown including a processing unit 208 (e.g., one or more processors), an I/O component 210, a memory 212 (e.g., a storage hierarchy), an external storage system 214, an input/output (I/O) device 216 (e.g., one or more I/O interfaces and/or devices), and a communications pathway 218. In general, processing unit 208 can execute program code, such as service management system 102, profile management system 130, transacting agent 140, etc., which can at least partially fixed in memory 212. While executing program code, processing unit 208 can process data, which can result in reading and/or writing transformed data from/to memory 212 and/or I/O device 216. Pathway 218 provides a communications link between each of the components in environment 200. I/O component 210 can comprise one or more human I/O devices, which enable a human user to interact with computer system 202 and/or one or more communications devices to enable a system user to communicate with the computer system 202 using any type of communications link. To this extent, computer system 202 can manage a set of interfaces (e.g., graphical user interface(s), application program interface(s), etc.) that enable system users to interact purchase enhancement program 206, e.g., included therein. Further, computing device 204 can manage (e.g., store, retrieve, create, manipulate, organize, present, etc.) data, through several modules 222 contained within service management system 102, modules 232 contained within profile management system 130, and/or modules 242 included within transacting agent 140. It is also understood that one or more modules 222, 232, 242 may be shared between and/or commonly accessible to service management system 102, profile management system 130, and transacting agent 140, in further embodiments.

As discussed herein, purchase enhancement program 206 can be embodied as a software component of computing device 240. In this case, modules 222, 232, 242 can enable computer system 202 to perform a set of tasks used by purchase enhancement program 206, and can be separately developed and/or implemented apart from other portions of purchase enhancement program 206. Computer system 202 can be operably connected to SP(s) 106, preferred SP(s) 108, and/or other systems 112 to pair user profile(s) in profile management system 130 with data and/or instructions pertaining to SPs 106, preferred SP(s) 108, and/or other systems 112. Computer system 202 can therefore enable an exchange of signals or other information between the variously connected SPs, systems, etc., such that transacting agent computer system 202 generate and/or convey purchase enhancements to a user as discussed herein. Process steps for conveying purchase enhancements are discussed in detail elsewhere herein, e.g., by reference to the example process flow of FIG. 3.

Memory 212 can include various software modules 222, 232, 242 configured to perform different actions. Example modules can include, e.g., a comparator, a calculator, a list organizing/combining module, a determinator, etc. One or more modules 222, 232, 242 can use algorithm-based calculations, look up tables, software code, and/or similar tools stored in memory 212 for processing, analyzing, and operating on data to perform their respective functions. Each module discussed herein can obtain and/or operate on data from exterior components, units, systems, etc., or from memory 212 of computing device 204. Purchase enhancement program 206 can also generate and/or modify various forms of data (e.g., included in profile management system 130) to automatically convey purchase enhancements to users as described herein.

Where computer system 202 comprises multiple computing devices 204, each computing device 204 may have only a portion of purchase enhancement program 206 thereon (e.g., one or more modules). However, it is understood that computer system 202, service management system 102, profile management system 130 transacting agent 140, etc., are only representative of various possible equivalent computer systems and components thereon that may perform a process described herein. Computer system 202 can obtain or provide data, such as data stored in memory 212 or storage system 214, using any solution. For example, computer system 202 can generate and/or be used to generate data from one or more data stores, receive data from another system, send data to another system, etc.

Referring to FIGS. 1-3 together, an illustrative flow diagram of methods according to the present disclosure is shown. The example method steps disclosed herein can be implemented, e.g., by software instructions encoded on or accessible to computer system 202 and one or more of the parts thereof discussed elsewhere herein. Although example processes P1-P7 in FIG. 3 are shown as occurring in sequential order, it is understood that one or more of processes P1-P7 can be carried out in an alternative order, and/or simultaneously with other processes, where desired and applicable. It is further understood that one or more of the steps shown in FIG. 3 and discussed herein can be omitted where desired.

In process P1, shown in phantom to indicate an optional preliminary step, profile management system 130 (e.g., of computer system 202) can access one or more user profile(s) 132 included, e.g., within profile management system 130 or other data repository (e.g., storage system 214). Purchase enhancement program 206 can access one or more user profile(s) 132 to enable computer system 202 to convey one or more purchase enhancements to user(s) 120 interacting with SP(s) 106, 108. User profile(s) 132 can be accessed and/or created before, during, or after an interaction between user(s) 120 and SP(s) 106, 108. Where user profile(s) 132 are newly created in process P1, processes P2-P4 described herein can occur substantially simultaneously with each other or in reverse order via modules 232 of profile management system 130 prompting user(s) 120 to input various forms of identifying information. Computer system 202 can use information provided by user(s) 120 to create user profile 132 with this information, which may be accessed and/or modified in further processes as discussed herein. However implemented, computer system 202 can access user profile 132 of profile management system 130 to convey purchase enhancements to user(s) 120 according to embodiments described herein. In an embodiment, process P1 can include accessing a listing of users for a virtual casino or arcade, with the listing of users being stored as data in a single database or set of databases.

At process P2, also shown in phantom to indicate an optional process, modules 222 of service management system 102 can tag one or more SP(s) 106 accessible to user(s) 120 as being preferred SPs 108. Preferred SPs 108 may include a tag (e.g., tag(s) 110 (FIG. 1)), designation, etc., through software included therein and/or in service management system 102. An administrator of system 100 and/or computer system 202 may access purchase enhancement program 206 to select, tag, etc., preferred SPs 108 to achieve one or more administrative objectives. For example, preferred SPs 108 can include all SPs in the event of a sales promotion or integration of SPs 106 with a larger purchase enhancement system to encourage repeated use of SPs 106 by user(s) 120. In other cases, only a subset of SPs 106 may be tagged as preferred SPs 108 to encourage engagement with users 120, e.g., by conveying purchase enhancements as described herein. In an embodiment, process P2 can include selecting or modifying one or more games in a virtual casino, arcade, etc., to provide tokenized credit(s) 136 to user(s) 120 who play the selected games on preferred SPs 108. In such cases, the games in a virtual casino, arcade, etc., may otherwise be limited to providing only virtual rewards or entertainment to a user without any corresponding redeemable tokens, points, prizes, etc.

Embodiments of the disclosure can include identifying, e.g., in process P3, a transaction between user(s) 120 and/or associated user profile(s) 132 with SP(s) 106, 108. The identifying in process P3 can include, e.g., passively or actively detecting whether SP(s) 106, 108 receive an input, payment, and/or other interaction from user(s) 120 having user profile(s) 132 accessed in process P1. To this extent, service management system 102 can communicate with profile management system 130 and/or transacting agent 140 in process P3 to determine instances in which user profile(s) 132 engage SP(s) 106, 108. Any engagement (e.g., user interaction or other forms of use) between SP(s) 106, 108 and user(s) 120 and/or user profile(s) 132 may initiate the conveying of purchase enhancement(s) 146 to user(s) 120 in future process steps. In an example embodiment, process P3 may include detecting instances in which one or more users spend one or more forms of currency to play games in a virtual casino, arcade, etc., which have previously been selected or modified to dispense redeemable tokens, points, prizes, etc.

Continuing to process P4, embodiments of the disclosure can include applying tokenized credit(s) 136 (e.g., crediting, adding, adjusting a total number thereof, etc.) to user profile(s) 132 which entered into a transaction with SP(s) 106, 108 as determined in process P3. User profile(s) 132 which do not engage predetermined SP(s), e.g., SP(s) 106, may optionally not receive tokenized credits 136. In some cases, tokenized credit(s) 136 and/or other redeemable tokens (e.g., points, virtual currency, etc.) can accumulate over time in balance 134 of user profile(s) 132, e.g., each time one or more user profile(s) 132 engage SP(s) 106, 108. As shown, processes P3 and P4 can repeat in succession as particular user profile(s) 132 increase the amount of tokenized credit(s) 136, e.g., by repeatedly engaging SP(s) 106, 108. In the example of a virtual casino, arcade, etc., user participation in virtual games can increase a number of tokens, redeemable currency, and/or similar attributes of corresponding user profile(s) 132. The tokens and/or other forms of tokenized credit(s) 136 can then be independently redeemed for purchase enhancements distinct from any rewards and/or entertainment value generated directly by SP(s) 106, 108.

In process P5, credit conversion module 142 and/or other modules 242 of transacting agent 140 can convert tokenized credit(s) 136 to corresponding purchase enhancements 146. Transacting agent 140 can convert tokenized credit(s) 136 to one or more enhancements 146 by way of, e.g., user selection or automatic conversion based on one or more administrator inputs, algorithms, look-up tables, etc. In some cases, tokenized credits 136 may take the form of a specialized virtual currency included in balance 134 of user profile(s) 132. Tokenized credit(s) 136 thereby may be provided from a variety of SP(s) 106, 108 and/or interactions therewith. In an example, SP(s) 106, 108 may dispense tokenized credit(s) 136 through other processes described herein, e.g., P3 and P4, through a sweepstakes, entry of a lottery ticket serial number, virtual game, purchase of credits, purchase of virtual or physical items, and/or other transactions. Tokenized credit(s) 136 can also be separated into multiple categories, e.g., points, virtual currency, sweepstakes entries, winnings, etc., such that user(s) 120 may exchange or spend tokenized credit(s) 136 in one category to receive tokenized credit(s) 136 in another category. In any event, modules 242 of transacting agent 140 can convert tokenized credit(s) 136 or similar accumulated elements (e.g., points included in balance 134) of user profile(s) 132 for corresponding purchase enhancements 146, which may include non-virtual rewards (e.g., cash or other monetary rewards, physical products, services, etc.). Purchase enhancements converted from tokenized credit(s) 136 can thus include other tokenized credits 136, reward(s) 144, enhancement(s) 146, product modification(s) 148, and/or combinations thereof.

In the example of a virtual casino, arcade, etc., with multiple games in which users 120 may exchange actual currency for credits to play interactive games (i.e., a form of SP), the interactive games may be configured to only dispense virtual rewards or credits and/or may entertain the user without dispensing any rewards or credits. However, at process P5, an administrative system of the virtual casino, arcade, etc., (e.g., service management system 102) may allow users 120 of the virtual casino, arcade, etc., to receive non-virtual prizes as a reward for purchasing credits to play or playing (i.e., engaging) one or more of the interactive games. According to the example, service management system 102 can dispense tokenized credit(s) 136 to users 120 who purchase credits for playing interactive games. Transacting agent(s) 140 of the virtual casino, arcade, etc., can then allow users 120 to redeem accumulated tokenized credit(s) 136 for rewards not otherwise available in the virtual casino, arcade, etc.

Methods according to the disclosure can continue to process P6 in which modules 242 of transacting agent 140 automatically convey one or more purchase enhancements 146 to user profile(s) 132 of profile management system 130. For example, transacting agent 140 can instruct an external system to send one or more physical products, services, etc., redeemable coupons, sweepstakes entries, etc., to user(s) 120 immediately upon converting tokenized credit(s) 136 to corresponding purchase enhancements 146. In other embodiments, transacting agent 140 can apply a credit to one or more external account balances owned by user(s) 120 or otherwise dispense cash rewards to user(s) 120 associated with user profile(s) 132. In other embodiments, transacting agent 140 can convey purchase enhancement(s) 146 to user profile(s) 132, e.g., by enabling user(s) 120 to engage SP(s) 106 included in other system(s) 112 separate from interactive system(s) 104. For instance, where purchase enhancement(s) 146 take the form of a supplementary sweepstakes, transacting agent 140 may generate non-determinative user interaction(s) 150 to verify user(s) 120 and allow for redemption of rewards 144 offered through the sweepstakes. In the example of a virtual casino, arcade, etc., transacting agent 140 can convey one or more sweepstakes entries to user profile(s) 132 after user(s) 120 spend money to play interactive games. Embodiments which include providing a sweepstakes entry to user(s) 120 are discussed in further detail elsewhere herein. In contrast to the virtual prizes offered by machines within the virtual casino, arcade, etc., user(s) 120 may be eligible to win non-virtual prizes (e.g., cash, products, services, etc.) through the sweepstakes entries conveyed as enhancement(s) 146 to user profile(s) 132. To encourage repeated use of the virtual casino, arcade, etc., the sweepstakes entries conveyed as enhancement(s) 146 may have a higher probability of success than entries in other sweepstakes promotions offered in different settings.

The present disclosure can optionally continue to process P7 of conducting one or more sweepstakes events, e.g., concurrently with or after conveying purchase enhancement(s) 146 to user profile(s) 132. In process P7, user(s) 120 can exchange tokenized credit(s) 136 and/or purchase enhancement(s) 146 in the form of sweepstakes entries for the ability to receive one or more real or virtual sweepstakes rewards. Here, transacting agent 140 and/or other components discussed herein can assign each sweepstakes entry from each user to a reward pool from which one or more winning entries are selected. In process P7, transacting agent 140 and/or other components can randomly select one or more sweepstakes entries corresponding to specific users 120 as being a winning or non-winning entry. The conducting of a sweepstakes in process P7 may include, e.g., generating one or more non-determinative user interactions 150 for verifying user(s) 120 and/or providing entertainment when revealing reward(s) 144 to user(s) 120. It is also understood that conducting a sweepstakes in process P7 may be combined with one or more currently known or later developed platforms for offering pooled contests and/or social features for multiple user(s) 120. In such scenarios, several users 120 may pool each of their sweepstakes entries into one sweepstakes on condition that the proceeds of winning are split proportionately or non-proportionately between users 120 in the same pool. In such instances, non-determinative user interactions 150 may be provided to all users 120 in a single pool, and/or to one or more representative users 120 of the pool while being streamed, recorded, etc., for viewing by the other users 120.

The number of winning entries can be set by an administrator of service management system 102, e.g., five percent of entries will win, fifty percent of entries will win, ninety or more percent of entries will win, etc. Where reward(s) 144 are of relatively low value, the number of winning sweepstakes entries may be set deliberately to a high number to encourage continued use of SP(s) 106. A portion of the pool may also be reserved for external sweepstakes participants, e.g., user(s) 120 who participate by mailing in a purchase-free sweepstakes entry. Each sweepstakes entry in process P7 can then be designated as winning or non-winning through multiple categories. As examples, winning or non-winning sweepstakes entries can include cash, product, or service rewards of varying value, varying amounts of additional sweepstakes entries, virtual currency in varying amounts and/or corresponding values, and/or sweepstakes entries with no corresponding reward. It is thus understood that an administrator of service management system 102 can combine the various example categories discussed herein and/or offer different types of winning or non-winning sweepstakes entries. Conducting a sweepstakes in process P7 can include generating non-determinative user interaction 150 in the form of, e.g., an interactive game, animation, video, etc., to reveal the sweepstakes results and thereby increase the entertainment value of the sweepstakes in process P7. However presented, non-determinative user interaction 150 may enhance the entertainment value for user(s) 120 and verify specific user(s) 120 without having any effect on the actual contest results to user(s) 120. In still further embodiments, one or more sweepstakes contests conducted in process P7 may be digitally available only to selected user(s) 120, e.g., user(s) 120 having a user profile 134 with a corresponding status level. All sweepstakes contests may be otherwise available to external users in compliance with corresponding terms of use, sweepstakes regulations, etc. It is understood, that conducting a sweepstakes in process P7 may not require or depend upon input by user(s) 120, and may only require calculation and/or independent processing by service management system 102, transacting agent 140, etc.

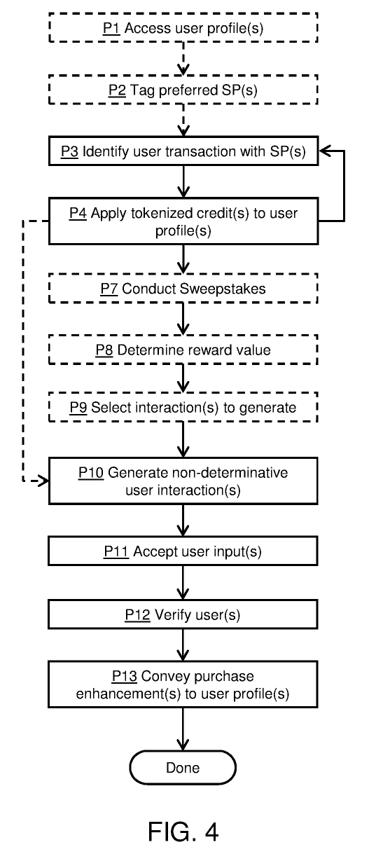

Turning now to FIGS. 1, 2, and 4 together, additional methods of conveying purchase enhancements to user(s) 120 according to embodiments of the disclosure are discussed. According to further embodiments, processes P1-P4 may proceed substantially as discussed elsewhere herein, e.g., relative to FIG. 3, but with additional processes and/or modifications relative to process P7. The example process flow of FIG. 4 is provided for the sake of demonstrating, e.g., additional features and/or uses of non-determinative user interactions 150. As discussed elsewhere herein, user(s) 120 may receive tokenized credit(s) 136 in the form of entries into a sweepstakes conducted through transacting agent 140. After tokenized credit(s) 136 associated with sweepstakes entries are applied to user(s) 120 in process P4, the method flow may continue to process P7 of conducting the sweepstakes based on sweepstakes entries applied to user(s) 120. After the sweepstakes concludes, the method may proceed to process P8 of determining a reward value for each sweepstakes entry (i.e., tokenized credit(s) 136) for user(s) 120. According to an example, process P8 may include matching winning sweepstakes entry numbers with those of particular user(s) 120 to determine the redemption value and/or reward(s) 144 associated with each tokenized credit 136. In cases where sweepstakes winners are divided into tiers of rewards (e.g., highest value, medium value, lowest value, etc.) process P8 may include selecting one of a plurality of possible categories which correspond to a particular entry by user(s) 120.

As discussed elsewhere herein, non-determinative user interaction(s) 150 may have no effect on the redemption value of each sweepstakes entry associated with tokenized credit(s) 136. In other words, non-determinative user interaction(s) 150 are included to verify user(s) 120 and provide user(s) 120 with entertainment during the process of learning whether they have won a sweepstakes. At process P9, transacting agent 140 may select one or more non-determinative user interactions 150 which correspond to the reward value(s) determined in process P8. As discussed elsewhere herein, non-determinative user interaction(s) 150 may take the form of a simulated game interaction by user(s) 120. At process P9, transacting agent 140 may determine, e.g., the total number of points to be granted to user(s) 120 or user profile(s) 132 during the user's input to non-determinative user interaction(s) 150.

Continued operation according to the present disclosure may include, at process P10, transacting agent 140 generating non-determinative user interaction(s) 150, e.g., based on the selecting in process P9 or immediately after tokenized credit(s) 136 have been applied to user(s) 120 in process P4. It is therefore understood that the determining of reward(s) 144 for tokenized credit(s) 136 may occur as part of a single process for generating non-determinative user interaction(s) 150 in process P10. Generating non-determinative user interaction(s) 150 may be followed by accepting user input(s) in process P11, e.g., to entertain user(s) 120 via non-determinative user interaction(s) 150. Various implementations of non-determinative user interactions to be generated in process P10 are therefore discussed for the sake of example.

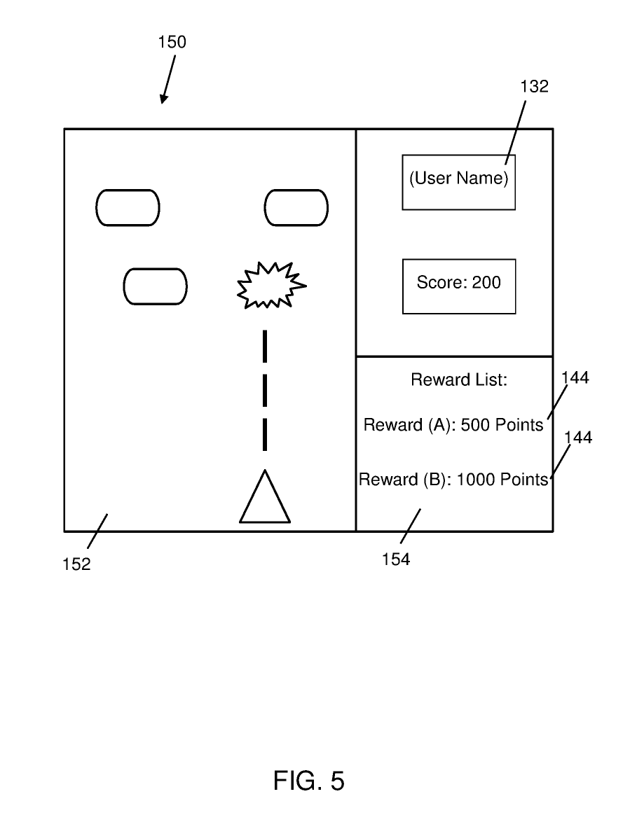

Referring to FIGS. 4 and 5 together, an example embodiment of non-determinative user-interaction is provided in FIG. 5. In the example of FIG. 5, non-determinative user interaction may take the form of a simulated arcade game, e.g., in which user(s) 120 are tasked with scoring points by shooting a predetermined number of targets. It is emphasized that in the present example, it is impossible for user(s) 120 to score less or more than a predetermined number of points, and that the only way to fail non-determinative user interaction 150 is for user(s) 120 to simply not participate in the simulated game. A play field 152 may depict, for example, a craft to be controlled by user(s) 120 and capable of firing at various targets. User profile 132 may be displayed adjacent to play field 152 with a current number of points or score. In FIG. 5, the user has destroyed one of four targets and accumulated two-hundred (200) points.

A reward list 154 may also be shown adjacent to play field 152, e.g., to display one or more possible rewards 144 (FIG. 1) to be accumulated with corresponding numbers of points. In the current example, user(s) 120 would accumulate eight-hundred points after destroying all four targets and thus be eligible to receive only the first reward on reward list 154. The number of targets in play field 152 may be determined based on, e.g., the outcome of a sweepstakes as discussed elsewhere herein relative to processes P7, P8. In cases where a sweepstakes entry is not eligible for any rewards (which may be, e.g., a minority of cases as noted elsewhere herein), the number of targets in play field 152 may be less than the minimum number of points in reward list 154. Conversely, sweepstakes entries redeemable for a larger number and/or a more valuable prize may cause transacting agent 140 to generate non-determinative user interaction 150 with five or more targets in pay field 152. The larger number of targets will allow user(s) 120 to receive enough points for more rewards 144 in reward list 152. It is again emphasized that the user's interaction with non-determinative user interaction 150 does not decide which rewards 144 in reward list 154 each user will receive, as the number of targets in play field 152 predetermines the outcome of non-determinative user interaction 150. Nonetheless, non-determinative user interaction 150 is configured to verify that user(s) 120 are human operators of purchase enhancement system 100, and to increase the enjoyment of users 120 as they interact with system 100.

Non-determinative user interactions 150 are not limited to the specific example provided in FIG. 5, and other types of non-determinative user interactions 150 may be used in various embodiments of the disclosure. Non-determinative user interactions 150 may generally take the form of any simulated game interaction which may give user(s) 120 the illusion that their actions determine the outcome of the game. Thus, the example of selecting a number of targets and obtainable points may be only one example of providing this illusion of game play to user(s) 120.

According to a first example, non-determinative user interaction(s) 150 may take the form of a blackjack, poker, or other card game where user(s) 120 are presented with a deck of cards. User(s) 120 may assume from presentation that they are drawing cards at random and reveling specific cards based on random chance, when in actuality the outcome of the game has already been determined. According to this example, user(s) 120 may need to match a predetermined number of points or draw a hand of cards to defeat an opponent's hand. Non-determinative user interaction(s) 150 may be scripted such that user(s) 120 will draw a predetermined hand of cards matching the result of a sweepstakes, e.g., drawing a winning or losing hand. User(s) 120 nonetheless may be required to select an option of drawing cards and/or playing cards to complete non-determinative user interaction(s) 150, thereby allowing transacting agent 140 to verify that human users are interacting with system 100, e.g., through transacting agent 140.

According to an additional example, non-determinative user interaction 150 may take the form of a bingo game in which a set of bingo cards are presented to user(s) 120. User(s) 120 selecting a card for play may be the criterion by which one or more user(s) 120 are verified as interacting with system 100. After user(s) 120 select a bingo card, an animation, video, etc., will play in which numbers are drawn from a bingo hopper. If user(s) 120 were previously selected as a winner, the numbers drawn from the hopper will match those shown on the selected card. If the sweepstakes entry is a non-winning entry, the numbers will not match. In either scenario, the user's selection of a card at the beginning of non-determinative user interaction will not affect whether the user wins. Instead, the set of winning or non-winning numbers will be chosen, after the user's selection, to match or not match the previously chosen card.

Non-determinative user interaction 150 may be configured to provide interactive features for multiple users at once. One such example may include providing a lottery drawing for a group of user(s) 120 participating in the same sweepstakes. In this case, each user 120 may be assigned a unique set of numbers such that no two users 120 receive the same set of numbers. Even before the drawing begins, one or more users 120 may be pre-selected to receive a set of numbers which will be drawn from a pool of numbers when the lottery occurs. At the time of the lottery event, the winning entrants will have their numbers chosen and presented to all users 120 as being the winning entrants of a particular drawing. This will create the impression that the winning users 120 were chosen at the time of the drawing, when in fact they were selected previously before the drawing occurred. Delaying the notification to users 120 of whether they have won until the time of the drawing may enrich the experience of each user 120, and may be used to determine whether user(s) 120 are present or logged into user account 132 at the time of the drawing.

Additional examples of non-determinative user interaction 150 may include non-conventional interactive elements or experiences to provide greater variety. In yet another example, non-determinative user interaction 150 may take the form of a virtual environment in which user(s) 120 are asked to choose five items from a set of twelve items. The user may also be instructed that if three of their selected items match a set of three winning items, user(s) 120 will receive corresponding reward(s) 144. User(s) 120 may be left with the impression that their choice of items will determine the outcome of the scenario. However, the items selected as matching or non-watching the selection by user(s) 120 may only be chosen after user(s) 120 have finished choosing their set of five items. The determination of whether user(s) 120 have a matching set of items may be based on whether user(s) 120 have already won a corresponding sweepstakes, e.g., as discussed elsewhere herein.

It is possible to generate non-determinative user interactions 150 for use with multiple users 120 simultaneously, e.g., to simulate participation in a competitive or cooperative game environment. Such implementations may have additional entertainment and/or verification value where several users 120 desire to pool their entries into one sweepstakes. According to an embodiment, non-determinative user interaction 150 may be provided to several users in the form of a simulated game show. After selecting the winner(s) of a sweepstakes through process P7, methods according to the disclosure may include teleporting a virtual avatar of one or more users 120 to a viewable area of a simulated environment. Users teleported to the particular area may interact with one or more avatars, non-player-characters, environmental objects (e.g., game tables, roulette wheels, decks of cards, slot machines, etc.) to reveal the results of the sweepstakes. In such cases, other users 120 in the same pool may be able to view the teleported user(s) 120 avatars and/or interact with the same environment while other user(s) complete non-determinative user interaction(s) 150. In addition to verifying the identity, or identities, of user(s) 120 in a single pool or competitive sweepstakes group, the generating of non-determinative user interaction(s) 150 in a shared virtual environment may increase the enjoyment and appeal of participation in a sweepstakes.

In an additional non-limiting example, non-determinative user interaction 150 may be presented to user(s) 120 as a slot game where each reel is stopped to reveal a winning or non-winning set of icons. User(s) 120 may assume from the presentation that their timing for each reel determines whether a particular icon appears. However, the results of the slot game may have been previously generated via conducting a sweepstakes in process P7. In other words, user(s) 120 will receive a winning line if they have been chosen at random to win the sweepstakes, and will receive a non-winning line if they were not chosen at random to win the sweepstakes. In either case, the action of user(s) 120 stopping each reel in the slot game may verify that human user(s) 120 are interacting with system 100. In addition, as with each instance of non-determinative user interaction 150, the use of a simulated game interaction may increase a user's enjoyment of interacting with transacting agent 140, as compared to the use of a more simplified sweepstakes interface. In view of the above, non-determinative user interaction 150 may take the form of any simulated game interaction, in which the outcome of the simulated game is driven solely by the previous use of tokenized credits 136 in process P4, and/or the conducting of a sweepstakes in process P7.

Returning to FIG. 4, process P11 may include accepting user inputs to transacting agent 140, or more generally to system 100, regardless of which non-determinative user interaction(s) 150 is/are generated in process P10. The accepting of user inputs at process P11 may verify that user(s) 120 are human users. At process P12, the method may include verifying each user 120 based on whether they have completed the corresponding non-determinative user interaction(s) 150 generated at process P10. For each verified user 120, the method may continue to process P13 of conveying one or more purchase enhancements (e.g., reward(s) 144, enhancement(s) 146, product modification(s) 148, etc.) to verified user(s) 120. From the perspective of verified user(s) 120, system 100 creates the illusion of winning or not winning a particular sweepstakes during the performance of non-determinative user interaction(s) 150, despite their winning or non-winning status being determined previously, e.g., at processes P4 and/or P7. The methodology may then conclude (“Done”), or repeat for the next sweepstakes and/or other distribution of purchase enhancements to user(s) 120.

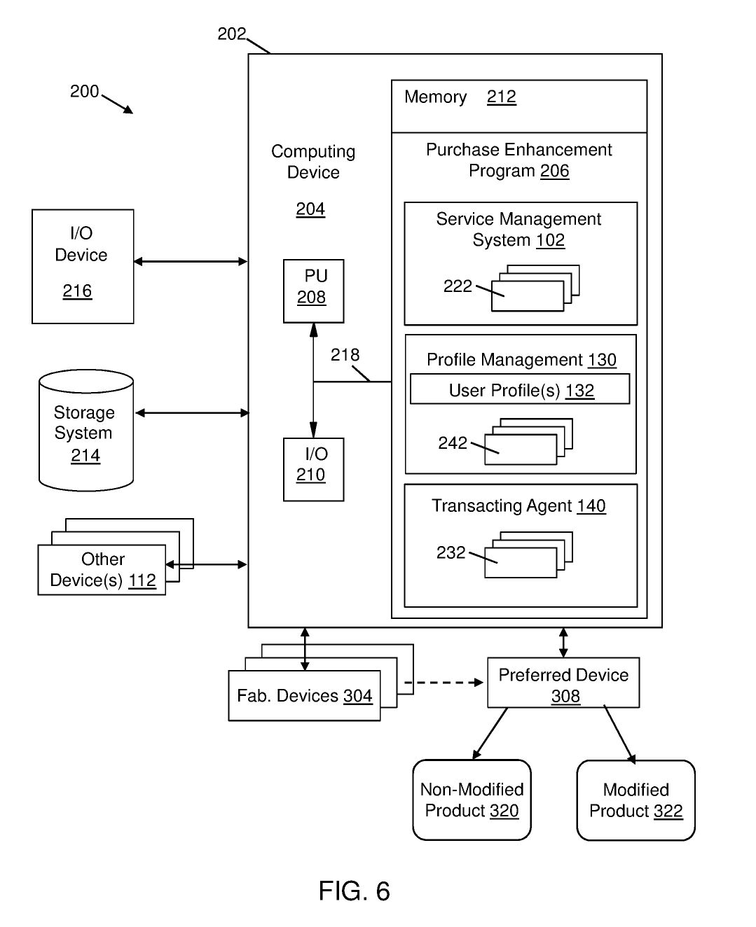

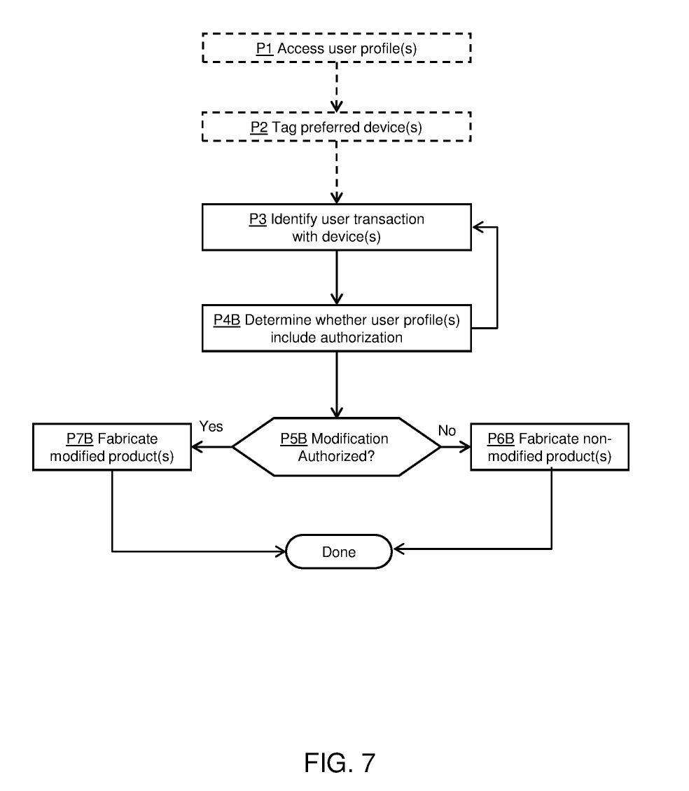

Referring to FIGS. 1, 6 and 7 together, embodiments of the disclosure can additionally or alternatively include modified process flows as illustrated by example in FIG. 7. It is understood that the various alternatively processes described herein may be implemented as an addition to or substitute for the various processes described herein relative to FIG. 4. For example, environment 200 may include computer system 202 communicatively connected to a group of fabrication devices 304, e.g., vending machines or rapid manufacture SPs for dispensing one or more products directly to user(s) 120. To encourage the use of one or more specific devices, service management system 102 can tag one or more devices as being a preferred device 308 in a manner similar to that of preferred SP(s) 106, e.g., by one or more tags 110 being applied thereto as discussed herein.

Preferred device 308 can then be configured to yield a non-modified product 320 or a modified product 322 (e.g., a product with one or more enhancements or changes from its base version) to reward users 120 in a manner similar to purchase enhancements 146 described elsewhere herein. In an example, non-modified product 320 may include a computerized device having one or more integrated circuit chips. To produce modified product 322, preferred device 308 can activate, deactivate, or otherwise modify targeted circuit structures to provide a modified functionality of modified product 322 relative to other products. In the example of a virtual casino, preferred device 308 can reward a user with modified or upgraded product versions as a reward for participating in games which otherwise only offer virtual rewards. In any case, modules 242 of transacting agent 140 can determine in process P4B whether user profile(s) 132 includes one or more authorizations 138 to receive modified product(s) 322 from preferred device(s) 308. At process P5B, a determinator module of modules 242 can validate or not validate the purchase of modified product(s) 322 based on data included within user profile(s) 132. In the event that user profile 132 is not authorized to receive a modified product (i.e., “No” at process P5B), the flow can proceed to process P6B in which preferred device(s) 308 fabricate non-modified product(s) 320. In situations where user profile 132 is authorized to receive a modified product (i.e. “Yes” at process P5B), the flow can proceed to process P7B in which preferred device(s) 308 fabricate modified product(s) 322. Thereafter, the method can include (“Done”) and may repeat for successive SPs 106, 108, devices 306, 308, users 120, etc.

Regardless, when computer system 202 includes multiple computing devices, the computing devices can communicate over any type of communications link. Further, while performing a process described herein, computer system 202 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

While shown and described herein as a method and system automatically conveying purchase enhancements, it is understood that aspects of the invention further provide various alternative embodiments. For example, in one embodiment, the invention provides a computer program fixed in at least one computer-readable medium, which when executed, enables a computer system to convey purchase enhancements to one or more users. To this extent, the computer-readable medium includes program code, such as purchase enhancement program 206, which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as purchase enhancement program 206, which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for creating and accessing computer system 202 (e.g., with purchase enhancement program 206 therein). In this case, a computer system, such as computer system 202, can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

Aspects of the invention can be implemented as part of a business method that performs a process described herein on a subscription, advertising, and/or fee basis. That is, a service provider could offer to send and receive encrypted messages as described herein. In this case, the service provider can manage (e.g., create, maintain, support, etc.) a computer system, such as computer system 202, that performs a process described herein for one or more customers. In return, the service provider can receive payment from the customer(s) under a subscription and/or fee agreement; receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method for automatically conveying a purchase enhancement, the method comprising:
identifying a transaction between a user and a point of service (SP), the SP being communicatively coupled to a transacting agent;
applying a tokenized credit to a user profile of the user based on the transaction between the user and the SP;
generating a non-determinative user interaction based on the tokenized credit;
verifying interaction by the user based on the non-determinative user interaction; and
automatically conveying a purchase enhancement to the user, based on the verifying.

2. The method of claim 1, wherein generating the non-determinative user interaction based on the tokenized credit further includes:
entering the user into a sweepstakes;
determining a reward value of the tokenized credit, based on the sweepstakes; and
selecting one of a plurality of non-determinative user interactions to generate, based on the reward value of the tokenized credit.

3. The method of claim 1, wherein the SP comprises a fabrication device for producing a product, and wherein automatically conveying the purchase enhancement includes modifying the product to provide a modified functionality.

4. The method of claim 1, wherein the SP comprises a device for dispensing a virtual currency to the user, and wherein automatically conveying the purchase enhancement includes furnishing a sweepstakes entry to the user, the sweepstakes entry providing a chance to earn one of an additional sweepstakes entry, a virtual currency or a non-virtual currency.

5. The method of claim 1, wherein the SP comprises a preferred SP from a plurality of SPs.

6. The method of claim 1, further comprising receiving an authorization from the user profile before converting the tokenized credit to the purchase enhancement, the tokenized credit being included in a point balance for the user profile.

7. The method of claim 1, wherein the non-determinative user interaction comprises a simulated game interaction.

8. A program product stored on a computer readable storage medium, the program product operable to automatically convey a purchase enhancement, the computer readable storage medium comprising program code for:
identifying a transaction between a user and a point of service (SP), the SP being communicatively coupled to a transacting agent;
applying a tokenized credit to a user profile of the user based on the transaction between the user and the SP;
generating a non-determinative user interaction based on the tokenized credit;
verifying interaction by the user based on the non-determinative user interaction; and
automatically conveying a purchase enhancement to the user, based on the verifying.

9. The program product of claim 8, wherein the program code for generating the non-determinative user interaction based on the tokenized credit further includes program code for:
entering the user into a sweepstakes;
determining a reward value of the tokenized credit, based on the sweepstakes; and
selecting one of a plurality of non-determinative user interactions to generate, based on the reward value of the tokenized credit.

10. The program product of claim 8, wherein the SP comprises a device for dispensing a virtual currency to the user, and wherein automatically conveying the purchase enhancement includes furnishing a sweepstakes entry to the user, the sweepstakes entry providing a chance to earn one of an additional sweepstakes entry, a virtual currency or a non-virtual currency.

11. The program product of claim 8, further comprising program code receiving an authorization from the user profile before converting the tokenized credit to the purchase enhancement, the tokenized credit being included in a point balance for the user profile.

12. The program product of claim 11, wherein the SP comprises a preferred SP from a plurality of SPs.

13. The program product of claim 11, wherein the non-determinative user interaction comprises a simulated game interaction.

14. A system for automatically conveying a purchase enhancement to a user, the system comprising:
a service management system stored in an electronic data processing system and configured to operate independently from a first plurality of user-engageable points of service (SPs), the service management system including program code for identifying a transaction between a user and an SP;
a transacting agent communicatively coupled to the SP, the transacting agent including program code for:
applying a tokenized credit to a user profile of the user based on the transaction between the user and the SP;
generating a non-determinative user interaction based on the tokenized credit;
verifying interaction by the user based on the non-determinative user interaction; and
automatically conveying a purchase enhancement to the user, based on the verifying.

15. The system of claim 14, wherein the program code for generating the non-determinative user interaction based on the tokenized credit further includes:
entering the user into a sweepstakes;
determining a reward value of the tokenized credit, based on the sweepstakes; and
selecting one of a plurality of non-determinative user interactions to generate, based on the reward value of the tokenized credit.

16. The system of claim 14, wherein the SP comprises a fabrication device for producing a product, and wherein automatically conveying the purchase enhancement includes modifying the product to provide a modified functionality.

17. The system of claim 14, wherein the SP comprises a device for dispensing a virtual currency to the user, and wherein automatically conveying the purchase enhancement includes furnishing a sweepstakes entry to the user, the sweepstakes entry providing a chance to earn one of an additional sweepstakes entry, a virtual currency or a non-virtual currency.

18. The system of claim 14, wherein the SP comprises a preferred SP from a plurality of SPs.

19. The system of claim 14, wherein the transacting agent further includes program code for receiving an authorization from the user profile before converting the tokenized credit to the purchase enhancement, the tokenized credit being included in a point balance for the user profile.

20. The system of claim 14, wherein the non-determinative user interaction comprises a simulated game interaction.
